(19) United States
(12) Patent Application Publication
(10) Pub. No.: US 2009/0238538 A1
(43) Pub. Date: Sep. 24, 2009

(54) SYSTEM AND METHOD FOR AUTOMATED COMPILATION AND EDITING OF PERSONALIZED VIDEOS INCLUDING ARCHIVED HISTORICAL CONTENT AND PERSONAL CONTENT

(76) Inventor: FRANKLIN E. FINK, Shaker Heights, OH (US)

Correspondence Address: ROETZEL & ANDRESS, 1375 EAST 9TH STREET, CLEVELAND, OH, 44114, US

(21) Appl. No.: 12/408,102

(22) Filed: Mar. 20, 2009

Related U.S. Application Data
(60) Provisional application No. 61/038,131, filed on Mar. 20, 2008.

(51) Int. Cl. H04N 5/91

(52) U.S. Cl. 386/83

(57) ABSTRACT

A personalized video system that combines user-supplied data and digital visual images or view with stored archival stock video footage and popular music works of the last century to generate a personalized life story documentary movie. The personalized video system gathers input from the user about the recipient such as age, gender, and relationship to the user and allows the user to upload personal digital images or video of the recipient. The user then inputs the dates of each digital image or video uploaded so that the personalized video system can chronologically order the items in the video. The personalized video system combines the user-supplied information and digital media with archived stock video footage of significant events and famous personalities to place the recipient's life story in a historical context. The personalized video system also provides a music soundtrack and synchronizes the display of the digital media and archived footage to the selected soundtrack. One embodiment allows the user to upload birth certificates, marriage certificates, newspaper clippings or other digitally scanned material for use in the video. Another embodiment allows the user to record or upload a voiceover narrative, sound effects or other audio content.

### RELATED APPLICATIONS

This application claims priority to U.S. Application No. 61/038,131 filed Mar. 20, 2008.

### FIELD OF THE INVENTION

The present disclosure and inventions pertain generally to methods for creating on-line personalized multimedia files, and more specifically to creating a personalized documentary video file or movie incorporating user-supplied digital images and home movies combined with archival stock video footage, and mixed and/or synchronized with a musical soundtrack.

### BACKGROUND OF THE INVENTION

With the advent of low-cost digital photography, consumers have been exploring new ways to share and distribute heirloom family images in an emotionally compelling way. A variety of related product categories have emerged in recent years to answer this need. Online photo sharing sites such as Snapfish, Shutterfly, Flickr, Bluestring, and Picasa Web Albums allow users to remotely store their photographs on remote web servers, and selectively share those images with friends and family. Social networking sites such as MySpace and Facebook feature photo sharing as a primary component of users' profiles. However, the vast majority of this activity represents merely the exchange of unadorned 4×6″ prints through digital means. No attempt is generally made to enhance the images or add other storytelling elements. Digital slideshow applications such as Smilebox and Fliptrack represent a significant advance over simple photo sharing, enabling users to distribute photo collections with a variety of creative enhancements such as backgrounds, transitions, captions, and synchronized music. These applications improve the user's ability to create compelling narratives, although they tend to be time-consuming to produce and are not intended to place the story in any sort of historical context.

Users wanting to create a more sweeping personal narrative have tended not to use Web. 2.0 photo sharing technologies, but instead have turned to independent professionals specializing in the production of multimedia works known as “Life Story Videos”, “Biography Videos”, or “Family History Videos.” These works are specially commissioned to commemorate an important life milestone, such as a birthday, anniversary, graduation, wedding, or the like. Producers will typically videotape one or more personal interviews with family members, and collect a variety of photos, home movies, documents, and other memorabilia about the subject. The collected materials will be digitally edited with stock archival footage, soundtrack music, audio/visual effects and titling to produce a professional-looking, personalized documentary film. These kinds of projects may take weeks or months to complete and may cost thousands of dollars, putting them beyond the reach of most consumers. Such productions are generally not practical for widespread consumer use, such as in connection with personalized electronic media and greetings.

### SUMMARY OF THE INVENTION

The present disclosure and related inventions include the elements of an internet-based methodology for quickly and easily producing personalized life story documentaries at a very low cost by automated or facilitated selection, editing, video effects and compiling functions for creating a customized or personalized video file. In one representative embodiment, a database of digitized stock archival film footage is collected featuring significant events and famous personalities of the past, or any historical information of any age or time period. A separate database includes a selection of popular musical works which may be indexed to or contemporaneous with the archival film footage or not. A web interface enables users to compile a personalized or customized documentary video file by initially answering a series of questions about the subject, such as, if for an individual: age, gender, and interests (i.e., news/events, sports, music, film, celebrities, etc.) and particular occasion if any. The user is then invited or prompted to upload a variety of effects, such as digital photos and/or videos, for example from different stages or eras of the recipient's life, tagging each with the approximate year taken and other relevant information. In alternate embodiments, any other digital images or files of any compatible type can also be uploaded and incorporated into the personalized or customized documentary video file, including but not limited to: news clippings, birth certificates, marriage licenses, diplomas, or any other material that is capable of being digitally scanned. In a further embodiment, the user can record or upload a voiceover narrative, sound effects, or other audio content to be played in combination with the personalized or customized documentary video file.

### DESCRIPTION OF THE DRAWINGS

FIG. 1 is a diagram representing the personalized video system platform;

FIG. 2 is a flow chart representing the services provided by the personalized video system;

FIG. 3 is a diagram representing the process of creating a personalized video;

FIG. 4 is a representative user input screen;

FIG. 5 is a representative ‘upload visual image’ screen, and

FIG. 6 is a representative ‘create a message’ screen.

### DETAILED DESCRIPTION OF PREFERRED AND ALTERNATE EMBODIMENTS

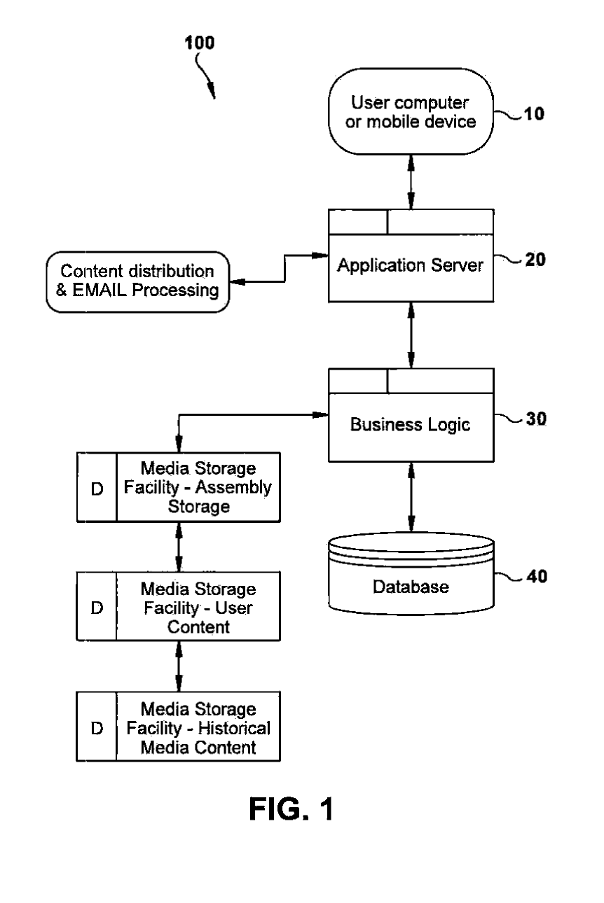

FIG. 1 illustrates a schematic embodiment of certain operative elements of a representative embodiment of a personalized or customized documentary video file creation system (hereinafter referred to generally as “personalized video system” or “system” configured to create a “personalized video”) of the disclosure and all related inventions. A user wishing to create a personalized video connects to the personalized video system 100 using a user computer or mobile device 10 which connects over the internet to an application server 20. It should be noted that although FIG. 1 illustrates only one user computer or mobile device 10, many remote computers can be simultaneously performing the steps of the present disclosure and related inventions. The application server 20 is where the business logic 30 and related algorithms of the system may be stored. The application server 20 writes information to and receives information from an application database server 40. The application database server 40 contains separate databases containing such information as user content, historical or archival media (video) content, and a music library. The application server 20 is also configured for content distribution and email processing of the program-generated personalized video.

As further described herein, the term ‘personalized video’ as used herein refers to a personalized life story, documentary-style video.

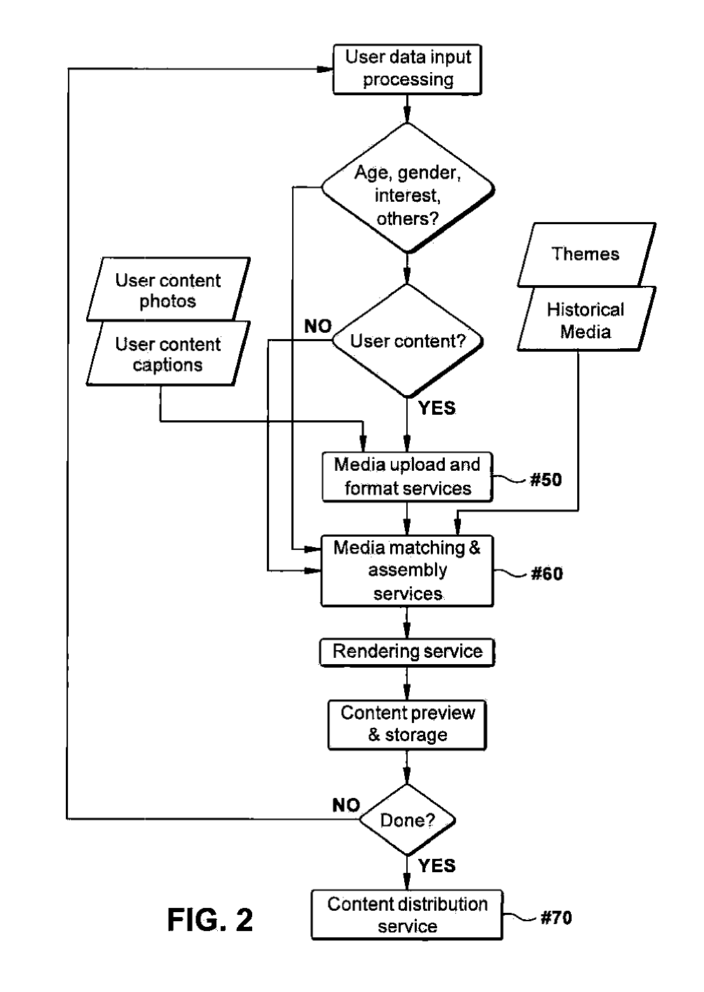

FIG. 2 contains a flow chart that identifies the services provided by the personalized video system and how they interact and respond to user input. The services provided by the personalized video system are the media upload and format services 50, media matching and assembly services 60, and the content distribution service 70. The media upload and format services 50 facilitate the upload of user supplied photos, video or music and are invoked whenever the user attempts to add any user-supplied files to the personalized video system. It also ensures that the files uploaded by the user are in a proper readable format. Once the pictures, video or music has been uploaded successfully, these files are passed to and used by the media matching and assembly services 60. These services include the algorithms that essentially assemble and create the personalized video. Once the video has been assembled, the user has the option of previewing, editing or further customizing the video. Once satisfied, the video is passed to the content distribution services 70 where various forms of distribution of the video are available. The personalized video may be distributed through a variety of means, including e-mail, private web pages, links on social networking pages, DVD, or other electronic formats.

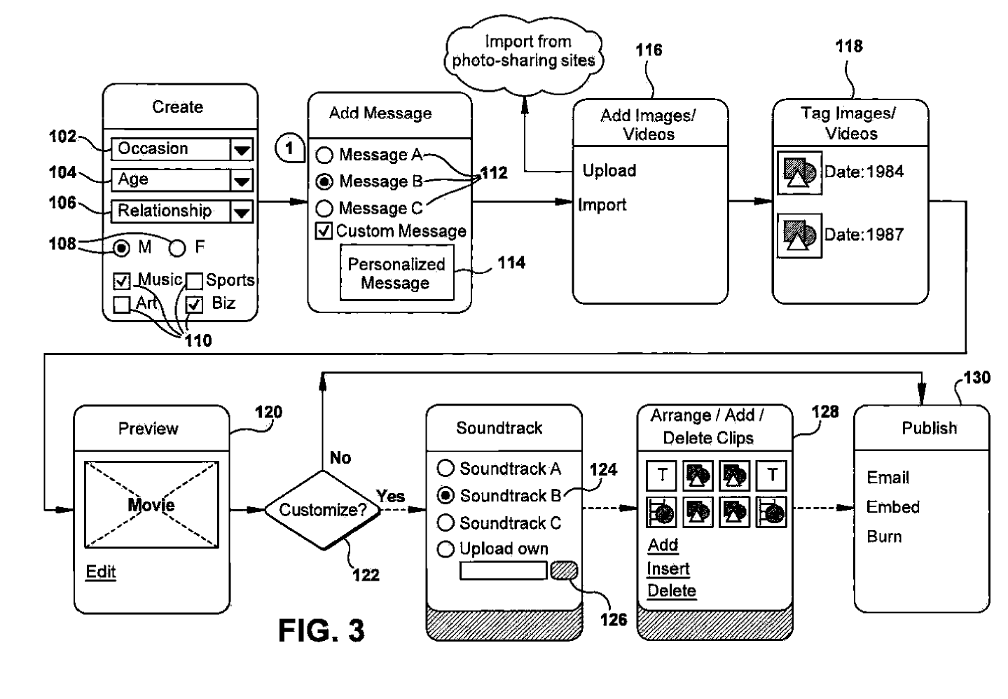

FIG. 3 contains a flow chart representing the process involved in creating a personalized video, from the user's perspective. As mentioned above, a user wishing to create a personalized video connects over the internet to the personalized video system 100 using a computer or mobile device 10. The first step in creating the video is to construct a profile of the recipient by selecting the occasion for the video 102, if any, the recipient's age 104, the user's relationship to the recipient 106, the recipient's gender 108, and the recipient's interests 110 (music, sports, art, business). The answers to each question are an important element in creating a video that captures elements of a recipient's life story or in creating a videographic mini-biography. The next step is to optionally add a message to be displayed as part of the personalized video. The message may be selected from three or more pre-defined messages 112 provided by the application. The user may also compose his or her own customized message 114, either in lieu of or in addition to the pre-defined message. The user will then be prompted to upload any visual images, photographs, or video 116. The user may import photos from one or several photo sharing websites or may simply upload them from a storage device such as a hard drive, CD or zip drive. It is preferred that the user upload at least three visual images, as personal photos are an important aspect of capturing the recipient's life story. However, photos or images are not required to produce a video. If photos or video have been uploaded, the next step is to tag or supply the date 118 of each photograph or video. This information will be used to chronologically order each of the provided visual images for presentation in the documentary-styled video. The user will also have the option of adding captions to the uploaded photos. If there are no user-supplied images or if the user has completed uploading and tagging, photos, the media matching and assembly process begins.

The media matching and assembly process is accomplished by a series of algorithms that consider the user-supplied data and user-supplied photographs, if any, to produce a personalized video. The personalized video system contains a collection of digitized stock archival still and motion picture footage featuring significant events and famous personalities of the last century. One component of the media matching and assembly process 60 involves selecting the appropriate archive footage based upon the user-supplied information given in response to the questions about the recipient. The recipient's age, gender, and general interests are all regarded by the algorithm when selecting the appropriate archive materials. For example, if the recipient is a twenty-eight year-old male whose interests include sports and more specifically, basketball, the algorithm would likely select sports-related archival footage, such as perhaps the Chicago Bull's Michael Jordan winning a third consecutive NBA championship in 1993. Likewise, if the recipient is a forty year-old male who was born in July of 1969, the algorithm may select archival footage of Neil Armstrong's walk on the Moon on Jul. 21, 1969.

The user-supplied answers to questions posed about the recipient are also used by an algorithm to select appropriate music to be used as a background for the personalized video. The personalized video system contains a selection of popular musical works spanning the last century. The user may also upload music to be used in the video. The recipient's age, interests, relationship to the user, and the occasion for the video may all be used to select an appropriate soundtrack for the video. In addition to selecting the music, an algorithm will also be used to synchronize the display of visual images with the music. The music track selected by one algorithm will be used by another algorithm to analyze the beat patterns of the music so that the user-supplied photographs and archival footage will be displayed in fully timed synchronization with the music.

In addition to selecting appropriate archival footage and music and synchronizing the display of visual images with the music, algorithms may also be used as part of the video assembly process to enhance still images, add video effects (pan, zoom, etc.), and generate static or animated titles and captions.

Once the personalized video system has assembled the video, a preview 120 is presented to the user for viewing. If the user is satisfied with the video, he or she may complete the process. If the user is not satisfied with the video, he/she has the option of editing or further customizing 122 the video. Customizing the video may involve selecting different music 124 or uploading new music 126, or re-arranging, adding or deleting 128 video images from the video.

As mentioned above, once the user is satisfied with the video, the video is passed to the content distribution services 70 where various forms of distribution of the video 130 are available. The personalized video may be distributed through a variety of means, including e-mail, private web pages, links on social networking pages, DVD, or other electronic formats.

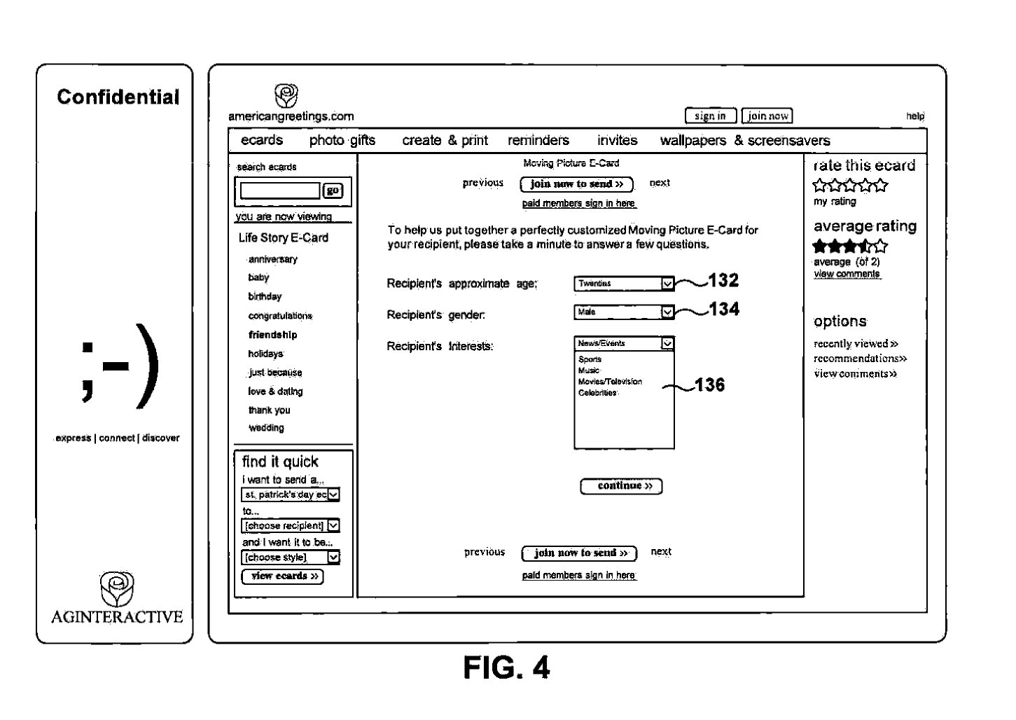

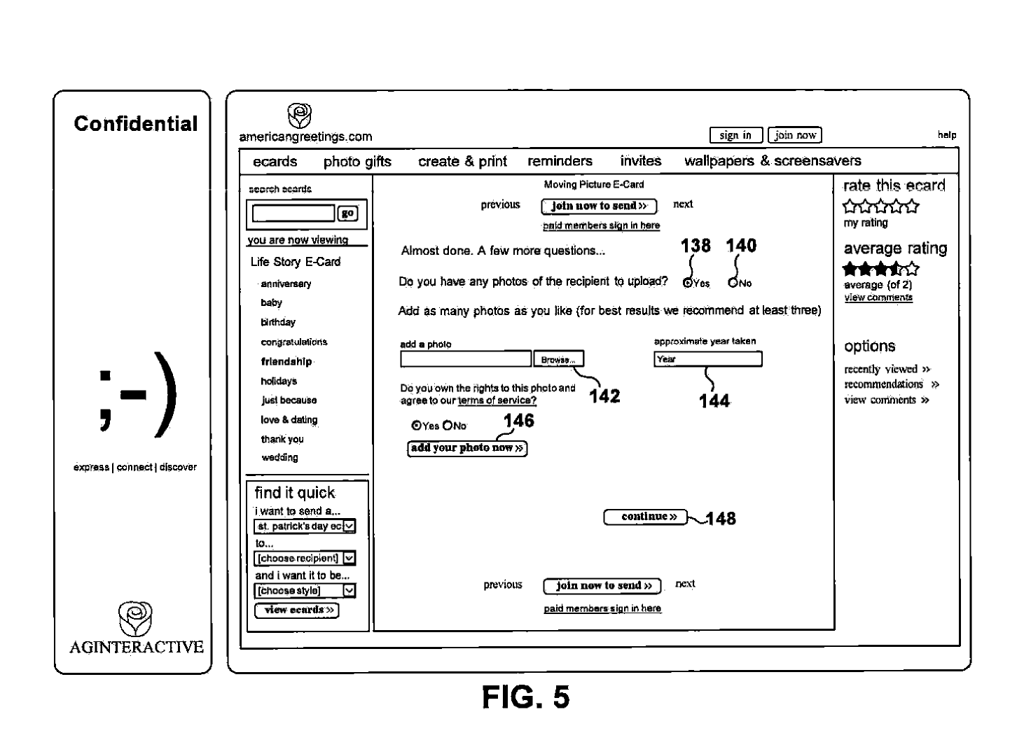

A representative user input screen is presented in FIG. 4. The user must select the approximate age of the recipient in the drop-down age menu 132, the recipient's gender in the drop-down gender menu 134, and select the recipient's interests from the drop-down interests menu 136. FIG. 5 is a representative user upload screen. The user must tell the system whether or not he/she has any photos to upload by selecting either the ‘yes’ 138 or ‘no’ radio button 140. If the user selects ‘no’ 140, then he/she can select the continue button 148 to proceed to the next screen. If the user selects ‘yes’ 138, then he/she may begin to upload photos by clicking on the browse button 142, directing, the system where to find the photos and entering the approximate year the photo was taken into the year text box 144. The user must agree to the terms of service and acknowledge that he/she owns the rights to the photo, in order to upload the photo by selecting the ‘add your photo now’ button 146. The same process is repeated for each photo selected to be added to the video. When the user is finished uploading photos, he/she may select the ‘continue’ button 148 to proceed to the caption or message screen.

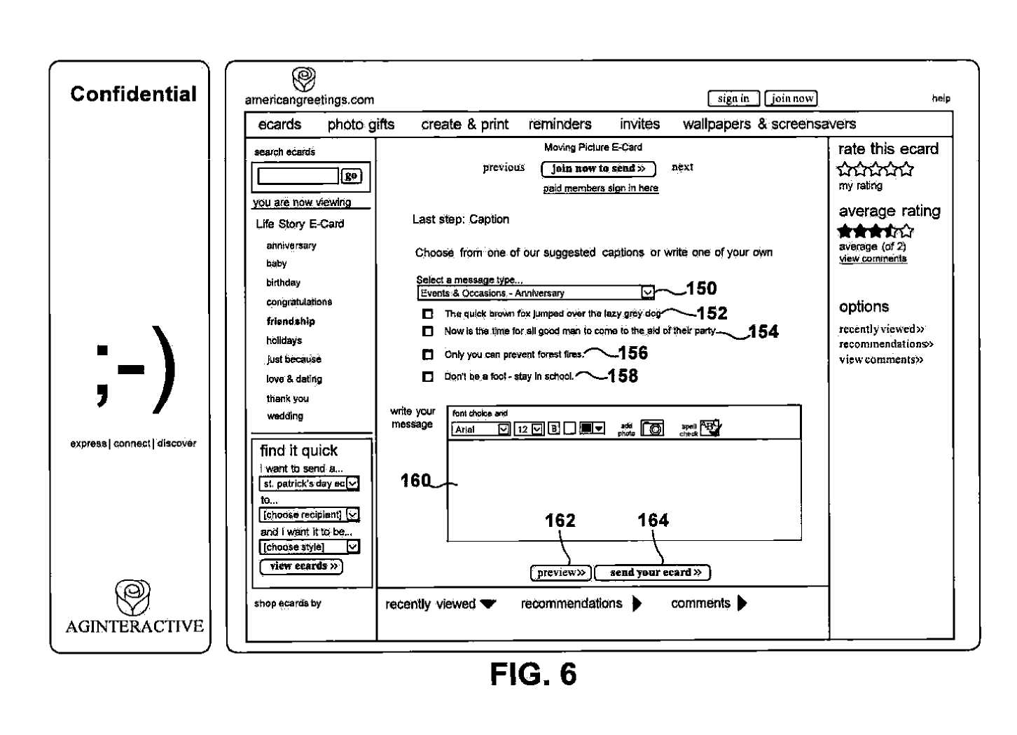

A representative caption or message screen is shown in FIG. 6. The user must first select a message type by choosing the event or occasion for the video from the drop down menu 150. After selecting the occasion, the personalized video system will display four pre-determined sentiments 152, 154, 156, 158 the user may choose to add to the video. To select a pre-determined message, the user must simply click on the check box next to the chosen message. The user may alternatively choose to customize a message and may do so by entering the customized text into the message box 160 located near the bottom of the screen. Finally, the user may preview the personalized video by selecting the ‘preview’ button 162 or may send or publish the video by selecting the ‘send your e-card’ button 164.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated.

1. A personalized video system comprising:
a personalized video platform configured and programmed to combine still images and video clips of historic events and famous people that are contemporaneous with user supplied information and effects and synchronized to music to generate a personalized video.

2. The personalized video system of claim 1 wherein the user supplied information includes the recipient's age, gender, and general interests.

3. The personalized video system of claim 1 wherein the user supplied effects includes digital images.

4. The personalized video system of claim 3 wherein the digital images include photographs.

5. The personalized video system of claim 3 wherein the digital images include any material that is capable of being digitally scanned.

6. The personalized video system of claim 1 wherein the user-supplied effects includes digital video.

7. The personalized video system of claim 1 wherein the user may also upload music files.

8. The personalized video system of claim 1 wherein the personalized video platform contains at least one user device connected via the internet to at least one application server.

9. The personalized video system of claim 1 wherein the application server contains at least one data storage device.

10. The personalized video system of claim 1 wherein the application server contains business logic.

11. The personalized video system of claim 1 wherein the application server contains an algorithm that selects a music clip for use in the personalized video based on the user-supplied information.

12. The personalized video system of claim 1 wherein the application server contains an algorithm that selects appropriate visual images of historic events for use in the personalized video based on the user-supplied information.

13. The personalized video system of claim 1 wherein the application server contains an algorithm that selects appropriate visual images of famous people for use in the personalized video based on the user-supplied information.

14. The personalized video system of claim 11 wherein the application server contains an algorithm that synchronizes the display of digital images and video with the selected music clip.

15. The personalized video system of claim 1 wherein the user can record a voiceover narrative for use in the personalized video.

16. The personalized video system of claim 1 wherein the user can record sound effects for use in the personalized video.

17. A method of creating a personalized video by following the steps comprised of:
using a computer or mobile device to connect to the personalized video system application server;
creating a recipient profile by entering the occasion for the video, the recipient's age, the relationship between the user and recipient, the recipient's gender and the recipient's interests;
selecting a pre-determined message or adding a customized message;
uploading digital images or videos;
adding the date that each digital image or video was taken;
initiating personalized video system; and
previewing the video.

18. The method of creating a personalized video of claim 17 wherein the digital images or videos can be imported from one or more photo sharing websites.

19. The method of creating a personalized video of claim 17 further comprising the step of customizing the personalized video system generated video by selecting a different soundtrack from the music library.

20. The method of creating a personalized video of claim 17 further comprising the step of re-arranging the order of presentation of digital images or video.

21. The method of creating a personalized video of claim 17 further comprising the step of adding additional digital images to the personalized video system.

22. The method of creating a personalized video of claim 17 further comprising the step of deleting digital images from the personalized video system.

23. The method of creating a personalized video of claim 17 further comprising the step of emailing the video to one or more recipients.

24. The method of creating a personalized video of claim 17 further comprising the step of embedding a link to the video on one or more social networking websites.

25. The method of creating a personalized video of claim 17 further comprising the step of embedding a link to the video on one or more personal websites.

26. The method of creating a personalized video of claim 17 further comprising the step of burning the video to a DVD.
